(19) United States
(12) Patent Application Publication
(10) Pub. No.: US 2010/0082477 A1
(43) Pub. Date: Apr. 1, 2010

(54) Method and system for loan and payment processing

(76) Inventors: Phillip C. Huston, Henderson, NV (US); Gordon K. Jones, Henderson, NV (US)

Correspondence Address: WEIDE & MILLER, LTD., 7251 W. LAKE MEAD BLVD., SUITE 530, LAS VEGAS, NV, 89128, US

(21) Appl. No.: 12/286,346

(22) Filed: Sep. 29, 2008

(51) Int. Cl. G06Q 40/00

(52) U.S. Cl. 705/38

(57) ABSTRACT

A method and system for processing loan applications and collecting loan payments is provided. As part of a loan application process, information is obtained to verify a consumer's banking information and conduct a bank account balance inquiry. If the loan application is approved, the loan may be funded using a consumer's bank account information. In a collection process, at the time of a scheduled payment, a balance inquiry is run against the consumer's bank account to determine if sufficient funds exist for payment. If not, then the attempt at collection may be rescheduled at a later time. If sufficient funds do exist, then a collection of the payment is initiated against the consumer's bank account as bank card transaction, thus ensuring payment.

### FIELD OF THE INVENTION

The present invention relates to methods and systems by which loans are provided to consumers and payments on such loans are collected.

### BACKGROUND OF THE INVENTION

Various types of consumer loans are known. In some cases, such as in the case of homes and cars, funds may be provided for the purchase of property and the property may be utilized as collateral for the loan. In these “secured” types of loans, a consumer may be permitted to make payments via mail or other means.

In other instances, funds may be provided directly to the consumer for various purposes and the loan may be unsecured. In such instances, it is highly desirable for the lender to directly obtain payment from the consumer.

For example, a consumer may need a loan of funds to cover emergency expenses or the like. Currently, the consumer generally submits an application to a lender. By the application the consumer provides bank account information.

The lender then transfers funds to the consumer's bank account. In this system, the bank account information is verified by the transfer of funds (if the funds are successfully transferred, it is known that the consumer's bank account exists).

So that the lender does not have to submit a request for payment to the consumer and wait for payment, the lender submits a request for payment to the consumer's bank account. In particular, the lender submits a payment request through the Automated Clearing House (ACH) network. The ACH processes the payment request through the consumer's bank.

If funds exist in the consumer's bank account at the time the ACH request is processed, payment is obtained from the consumer's account. However, this payment scheme suffers from a number of problems. A significant problem is that when the payment request is processed, there may not be any funds in the consumer's account. For example, at the beginning of a month a consumer might deposit their paycheck and then write a number of checks. Those checks and the other ACH payment requests are processed by the bank in a bank defined order. By the time a lender's ACH payment request is processed (which may be 2-3 banking days from submission), the processing of earlier queued checks may have depleted the funds in the consumer's account. In that instance, the ACH payment request is denied for insufficient funds.

If payment is denied, the lender is charged a return fee. In addition, the lender has to then pay to re-submit the payment request. However, at that time the lender still does not know if the consumer has funds in their account. Thus, the payment request may again be denied. Each time this occurs, the lender incurs fees and the consumer may be charged an insufficient funds charge by the bank.

As a result of this problem, lenders may abandon attempts to collect on a loan if the first payment request is unsuccessful. These losses then result in a higher cost to other consumers, such as in higher loan fees and interest rates.

An improved method and system for processing loans and payments is desired.

### SUMMARY OF THE INVENTION

Various aspects of the invention comprise methods for processing loan applications and methods for collecting loan payments. The invention has particular utility to unsecured consumer cash loans, and may be utilized for the collection of loan installment payments and/or loan principle balances.

In accordance with a method of the invention, loan applications are processed, loans are funded, and payments are collected.

As part of the loan application process, loan application information is received from a consumer and one or more verifications are performed. In one embodiment, the loan application information comprises personal information as well as banking verification information, preferably in the form of the ATM or debit card number for the consumer's bank account. A banking verification is performed. This preferably comprises verification of an address associated with the bank card against an address provided by the consumer as part of the loan application. In addition, in one embodiment, a balance inquiry may be performed of the consumer's bank account via the consumer's bank card in order to verify the existence of funds. Failure of the banking verification may result in denial of the loan application.

If the loan application is approved, the loan may be funded. As part of this process, if the consumer has not already done so, the consumer may provide bank account information, such as a bank account number and bank routing information. The lender may then transfer funds to the consumer.

In a collection process, at the time of a scheduled payment, using the ATM or debit card information, a balance inquiry is run against the consumer's bank account to determine if sufficient funds exist for payment. If not, then the attempt at collection may be rescheduled at a later time. If sufficient funds do exist, then a collection of the payment is initiated against the consumer's bank account and the funds are transferred.

In one embodiment, a lender transmits a loan collection request to a collection processor. The loan collection information may comprise information regarding a scheduled time for collection and an amount to be collected. Preferably, the collection processor initiates a balance inquiry of the consumer's bank account at the scheduled time. If sufficient funds exist, the collection processor preferably utilizes a merchant processor to effectuate a transfer of funds from the consumer's bank account via the consumer's bank account ATM or debit card. Funds collected by the merchant processor may be transferred to a holding account whereupon fees and charges are deducted, before transferring the remaining collected fees to a settlement account for disbursal to the lender.

In accordance with the invention, during a loan application process a lender can verify certain of a consumer's banking information and the existence of funds before approving a loan. In addition, before effectuating collection of a payment, funds existence is again confirmed. This process greatly enhances the probability that the lender lends to a consumer who is likely to pay (because the consumer's bank account and funds have been verified before the loan approval) and permits the lender to collect payment without risk of insufficient funds and without risk that if funds existed, the funds are removed before the payment is effected.

Further objects, features, and advantages of the present invention over the prior art will become apparent from the detailed description of the drawings which follows, when considered with the attached figures.

### DESCRIPTION OF THE DRAWINGS

FIG. 1 is a flow diagram of a method of the present invention;

FIG. 2 is a schematic illustrating a relationship between entities and elements in an environment of the invention;

FIG. 3 is a flow diagram of a collection process of the present invention;

FIG. 4 is another schematic illustrating a relationship between entities and element in an environment of the invention;

FIG. 5 illustrates an application authentication flow of an embodiment of the invention;

FIG. 6 illustrates a first payment collection flow of an embodiment of the invention;

FIG. 7 illustrates a second payment collection flow of an embodiment of the invention; and

FIG. 8 illustrates a third payment collection flow of an embodiment of the invention.

### DETAILED DESCRIPTION OF THE INVENTION

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

One embodiment of the invention is a method and system for processing loans and obtaining or collecting loan payments. In a preferred embodiment of the invention, loan payments are collected via bank account card debits or transfers after bank account funds verification.

As used herein, the term “consumer” means an individual, company or other entity seeking funds for themselves or another party. The term “lender” means an individual, company or entity which is willing to lend funds. The lent funds may belong to the lender or a third party.

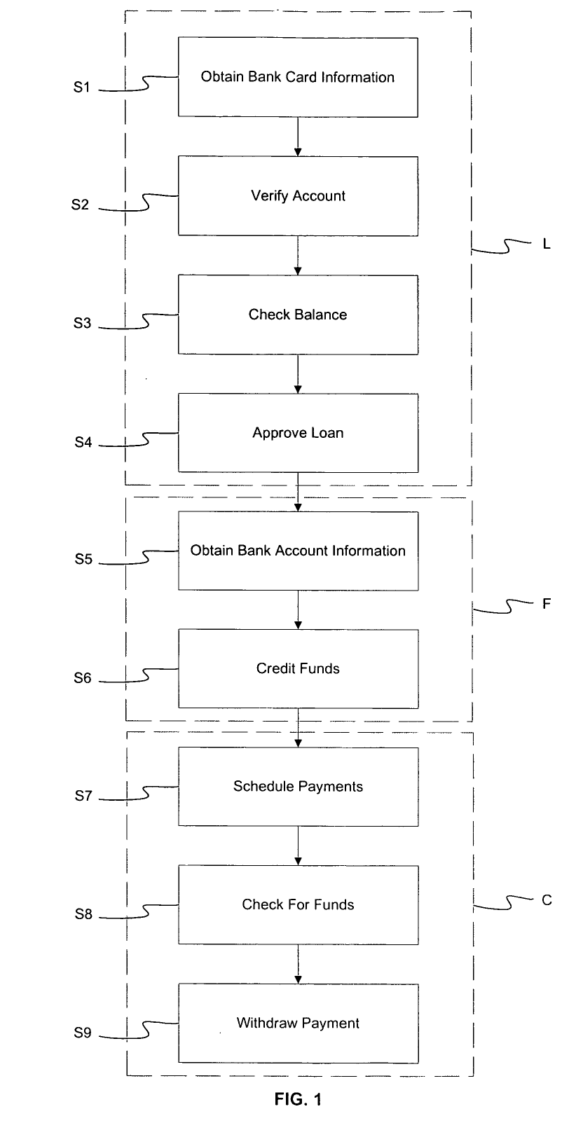

One embodiment of a method of the invention will be described with reference to FIG. 1. One aspect of the invention is an application and/or loan approval process L. Such an application may be for an unsecured consumer cash loan, but the method herein may be applied to other types of loans.

In one embodiment, a consumer applies for a loan. As part of the loan process, the consumer may fill out or provide “application” information. When accepted by a lender, this application may form a binding contract. The application may thus define the various material provisions of the loan, such as the loan amount, term, payment provisions and remedies in the event of default.

In accordance with the loan approval process, in a first step S1, a lender obtains banking verification information from a consumer. This information may be collected in various manners, such as by the consumer filling out a paper or electronic form, by telephone or other means. For example, the consumer might enter the information into an e-form which is accessible at a lender's website via the Internet. In addition, the lender might obtain this information indirectly, such as via a loan broker. It will be appreciated that the bank card information may be obtained from the consumer as part of the general loan application process.

In one embodiment, the banking verification information comprises personal information and bank card verification information. This may comprise the name of the consumer, their address, their social security number, their telephone number or other information. The bank card verification information preferably comprises the card number for the ATM or debit card corresponding to the consumer's bank account. The bank card information might also comprise the CVC or other secondary card number, the card expiration date and other information.

Of course, if the consumer fails to provide the required information, the loan application may be denied. In the case of a web-based application, the consumer may be notified of missing or incomplete information and be offered the opportunity to supplement that information.

In a step S2, the lender conducts a banking verification. In one embodiment, this comprises determining that the bank card information matches information provided by the consumer. In a preferred embodiment, the lender verifies that the address provided by the consumer matches the address associated with their bank card. Other information might be verified and/or other information may be obtained during the verification process. The verification process may be accomplished in various manners. In a preferred embodiment, address verification is performed via the known and existing Address Verification System (AVS).

If verification fails, then the loan application may be denied. For example, the loan may be denied if the address associated with the bank card and the address provided by the consumer vary from one another.

As part of the banking verification, in a step S3, the lender preferably checks the consumer's bank account for a balance (referred to herein as a “balance inquiry” or “BI”). In one embodiment, the lender checks to determine if a minimum balance, such as the amount of the first payment, exists in the bank account. In one embodiment, if there are no funds or insufficient funds associated with the bank account, the loan may be denied. This step is preferably performed by checking the account balance via the consumer's bank card, using the bank card information provided by the consumer.

In a step S4, the lender may elect to approve or deny the loan. The lender may deny the loan for the reasons set forth above. However, the lender may deny the loan for other reasons or based upon other criteria.

In a loan funding process F, the lender preferably obtains bank account information from the consumer, as in a step S5. Again, this information may be collected in various manners, including by written application, electronic form or the like. In one embodiment, the bank account information comprises the bank account number and the bank routing number. In one embodiment, the bank account information may be obtained at the same time as the bank card verification information (i.e. as part of the original application process). However, in other embodiments, this information may be obtained later. For example, at the time a consumer fills out a loan application, the consumer will know their personal information and will likely have their bank card (and thus bank card number) available. However, the consumer may not have their bank account number, bank routing number or the like available. In accordance with the invention, the lender is able to obtain the initial banking verification information from the consumer and conduct a banking verification (including account balance check) immediately without the bank account information. This streamlines the loan application process. If the initial banking information is not verified, no additional steps need to be taken. On the other hand, if that information is verified, the lender can inform the consumer that the funds can be transferred as soon as they provide their bank account information, thus incentivizing the consumer to provide the additional needed bank account information.

In a step S6, the lender may fund the loan. In one embodiment, this comprises the lender wiring or otherwise transferring funds to the consumer's bank account by use of the bank account information provided by the consumer. Of course, these funds may be provided from a funding account belonging to the lender.

Another aspect of the invention is a collection or payment process C. In one embodiment, in a step S7, the lender schedules payments. The payments are preferably defined by the loan application or contract with the consumer. The payments may comprise principal, interest or a combination thereof. The size and timing of the payment(s) may also vary, such as determined by the loan contract.

In a step S8, when a loan payment is scheduled, the lender (or as indicated below, a processor acting for the lender) checks the consumer's bank account for funds availability. Preferably, the account is checked via a bank card inquiry.

If insufficient funds exist for the scheduled payment, the scheduled payment may be moved to another time and the bank account may be rechecked. When the account is checked and sufficient funds exist, the payment is preferably made from the consumer's bank account. Preferably, as detailed below, this comprises debiting the amount of the payment from the consumer's account via a bank card transaction, such as a bank card debit transaction to the account. The funds are collected for the lender. Of course, the lender may then repeat this process upon the next scheduled payment.

As detailed below, it will be appreciated that the method of the invention may include additional or other steps, may not include all of the steps indicated above, and/or the sequence of various of the steps may differ. For example, as part of the loan approval process, a lender might conduct a bank card address verification, but not conduct a balance inquiry. Additional variations of the invention are detailed below.

As also detailed below, various of the steps of the invention may be performed via different parties. For example, in a preferred embodiment of the invention, balance inquiries, banking verifications and funds collections are all performed by one or more processing entities for and at the request of a lender. In this configuration, one or more processors may perform such steps as a paid service to various lenders, avoiding the need for the lenders to have to perform such actions themselves.

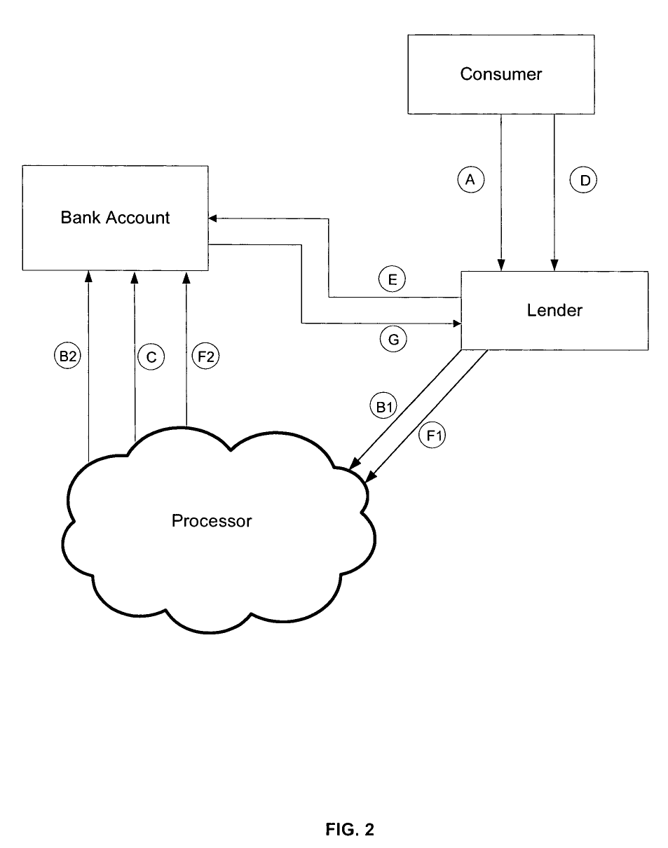

Further aspects of the invention will be described with reference to FIG. 2. FIG. 2 illustrates an environment of the invention, including various relationships between entities and elements thereof.

As illustrated, the environment may include at least one consumer or customer, at least one lender, a consumer's bank account, and one or more processors. The method described above will now be referenced to FIG. 2. As indicated, a consumer may provide bank card and/or other verification information to the lender, as at A. In response, the lender may send out a banking verification inquiry, as at B1. This account inquiry may preferably routed through the processor, which effectuates an inquiry, as at B2. As indicated, such a request may be to another processor or system, such as the AVS. Of course, such a request could also be directly to the consumer's bank. This inquiry may include an address verification/comparison as to the address associated with the consumer's bank card, and a balance inquiry, as at C. The results of the verification inquiry and balance inquiry may be transmitted back to the lender, such as through the processor.

If the loan is approved, the consumer may provide bank account information, as at D. In response, the lender may transfer funds to the consumer's bank account, as at E.

Upon a scheduled payment, the lender may transmit a payment request to the processor, as at F1. This request is preferably forwarded by the processor to the bank account, as at F2. As indicated below, such a request may again be through one or more third parties. For example, the processor's request for collection may preferably be made through a card processor and card processing system. If the payment request is successful, then funds are removed or disassociated from the bank account and transferred to the lender, as at G.

In a preferred embodiment, the environment of the invention includes or comprises a computing environment including one or more computing devices, computer readable code or software running on those devices, and one or more communication links, such as one or more communication networks. For example, a consumer may effectuate a loan application and provide the above-described information via a home or office computer. The required loan application information may be input by a consumer into an electronic form, such as via a form which is emailed to the lender, or via an on-line or web-based form. Information may be collected by the lender, such as via a server or other computing device. The lender may communicate application data and/or loan collection data to a server or other computing device of a processor. The processor may communicate with one or more banking or other systems in order to conduct verifications and process monetary transactions.

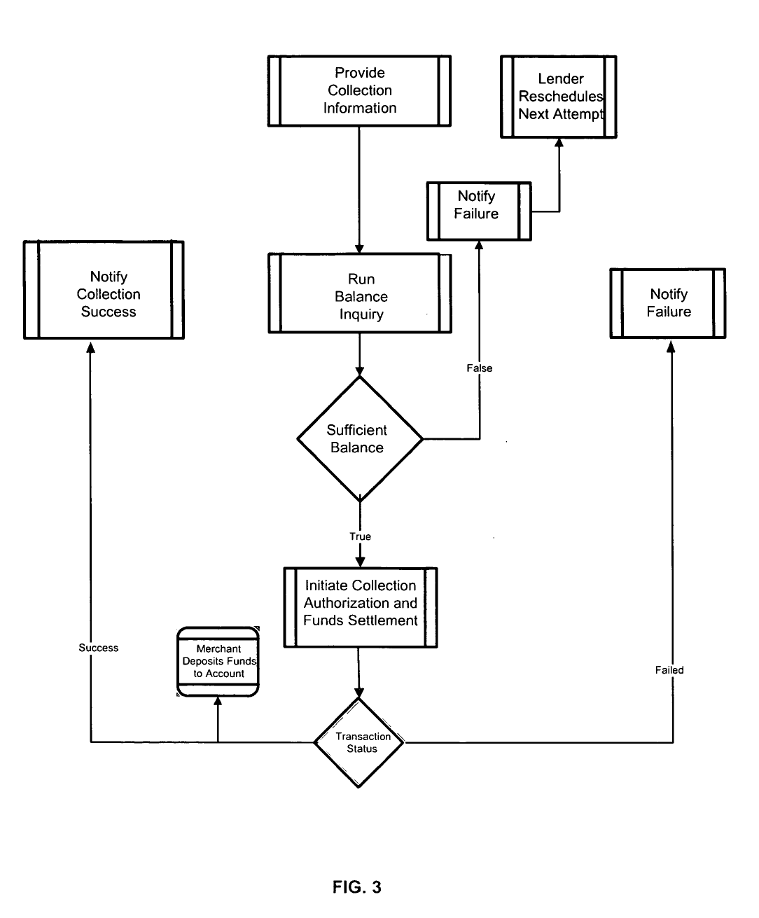

As indicated above, the invention may be implemented via various methodologies and in various formats or environments. FIG. 3 illustrates a particular collection process of an embodiment of the invention. In a step S101, collection or payment information is provided. This information may be provided by the lender to a collection processor. In one embodiment, a lender may enter into a contract with a collection processor for collection services. As part of this contract, a lender may be assigned a lender ID. When a lender approves a loan and sets it up for processing, the lender may assign the loan a loan ID and may transmit information regarding the consumer and loan to the processor. This might comprise, for example, a customer ID which identifies a file of information including the consumer's bank card and bank account information (thus eliminating the need for the lender to maintain the consumer's bank card information, and reducing the risk of fraud to the consumer).

Thus, in one embodiment, the information provided by a lender to a collection processor relative to loan payment collection may comprise one or more of: (1) a lender ID or other identifying information; (2) a lender loan ID to identify a particular loan; (3) a customer ID or other customer identifying information; (4) a transaction identifier; (5) transaction type information (detailed below); an (6) an amount to collect; and (7) one or more desired collection times.

In a step S102, the collection processor may run a balance inquiry relative to the one or more desired collections. As indicated, this may comprise the collection processor requesting a balance check of the customer's account via the customer's bank card. In a step S103, it is determined if there is a sufficient balance. This may comprise a comparison of bank account balance information to the desired amount to be collected. If there is an insufficient balance, in a step S104 the processor may notify the lender. This might comprise, for example an electronic notification to the lender. Thereafter, the lender may desire to reschedule the attempted collection, as at step 105. This might comprise the lender providing the processor with new “collection time” information, where upon the balance inquiry process at step S102 may be repeated at the new indicated collection time.

If there is a sufficient balance, then at step S106 the processor may initiate a collection authorization and funds settlement. In one embodiment, the collection authorization may be provided by the collection processor to one or more third party processors. In a preferred embodiment, the collection or payment process is accomplished as a bank card transaction against the consumer's bank account. Thus, in a preferred embodiment, the collection or payment process is performed via a merchant processor of the consumer's bank card, such as via the MasterCard® or VISA® systems and services. If the actual collection process is unsuccessful, a notification may be provided to the lender, such as at step S108. At such point, the lender might again attempt to reschedule the collection process. If the collection is successful, then collected funds are moved from the consumer's bank account to one or more other accounts, such as an account belonging to the lender or an intermediate settlement account (as detailed below), as at step S109. In that event, the lender may be notified of a successful collection process, as at step S110.

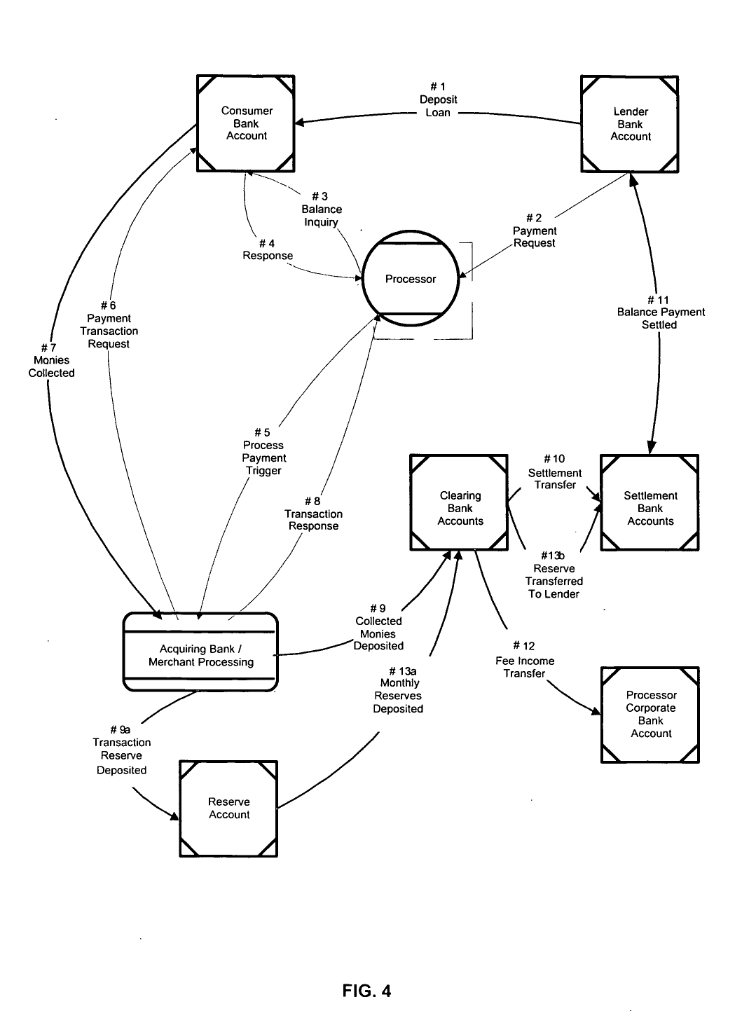

FIG. 4 illustrates another environment of the invention, and various relationships between entities and elements thereof, particularly relative to the flow of funds between entities (a “settlement flow”). As one aspect of the settlement flow, if a loan application is approved, a lender may deposit funds from their bank account to the consumer's bank account, as at #1. The lender may make a payment or collection request. As indicated, this request may be made by the lender to a collection processor, as at #2. At the desired collection time, the processor may run a balance inquiry against the consumer's bank account for the desired amount to be collected, as at #3. The response to that inquiry, as at #4 may result in a determination of a failure of the process (as indicated above) or may result in a request for authorization and settlement of the funds, as at #5. As indicated, the request for payment processing may be made by the processor to a third party, such as merchant fund processor. The merchant processor may send a payment transaction request tot the consumer's bank, as at #6. As indicated, such a request may fail. However, if successful, the consumer's bank transmits the requested funds back to the merchant processor (or an acquiring bank), as at #7. The merchant processor may report the results of the collection attempt to the processor (which may in turn report to the lender), as at #8.

Monies which are collected are preferably forwarded by the merchant processor/acquiring bank to a clearing bank account, as at #9. The collected monies may then be processed for settlement. This process may include deducting appropriate fees, such as transfer/processing fees and reserves fees. The remaining or settlement funds may be transferred to a settlement account, as at #10, where after the funds may be transferred to or obtained by the lender, as at #11.

Fees which are deducted from the collected funds may be transferred from the clearing bank accounts to a bank account of the processor otherwise appropriately distributed, as at #12. In one embodiment, certain of the collected funds may be set aside into a reserve bank account before they are deposited into the clearing bank account, as at #9a. In that event, excess reserves may be moved from the reserve account to the clearing bank account at one or more times (such as monthly), as at #13a, and then transferred to the lender, as at #13b.

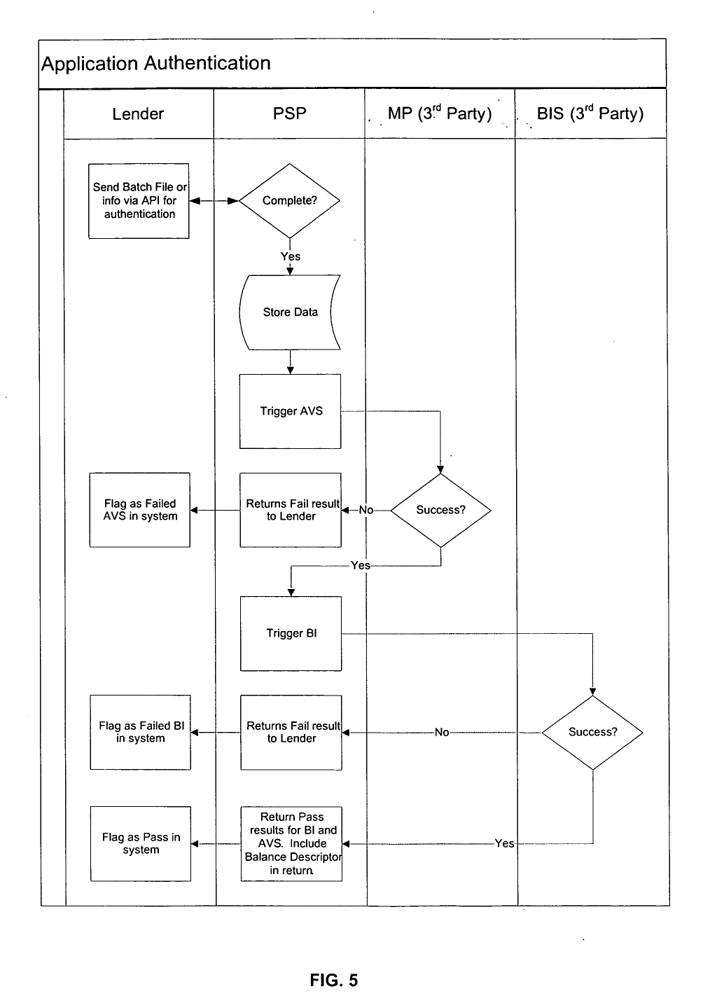

FIGS. 5-8 illustrate various process flows for various embodiments of the invention, with reference to various entities involved in the process. FIG. 5 illustrates one embodiment of a loan application process, showing the relationship between a lender, collection processor, merchant processor and BIS (balance inquiry service). In one embodiment, a lender sends application information electronically to the collection processor, such as via a batch file or via an API. The processor may then process that electronic information for conducting banking verification (via AVS, for example) and balance inquiry, as detailed above.

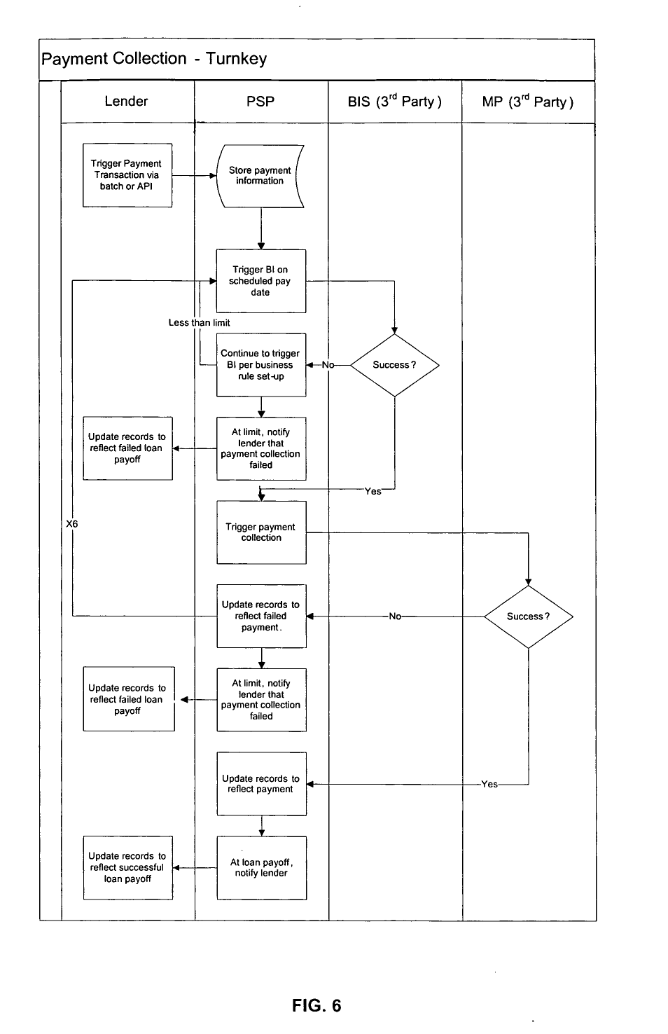

In one embodiment, the circumstances under which the collection process of the invention may be triggered or utilized may vary. For example, in one embodiment, a lender might sign up with a collection processor for “turnkey” processing. In this configuration, the lender may utilize the collection processor for the collection of all payments associated with a loan. FIG. 6 illustrates one embodiment of a payment collection process for such turnkey processing.

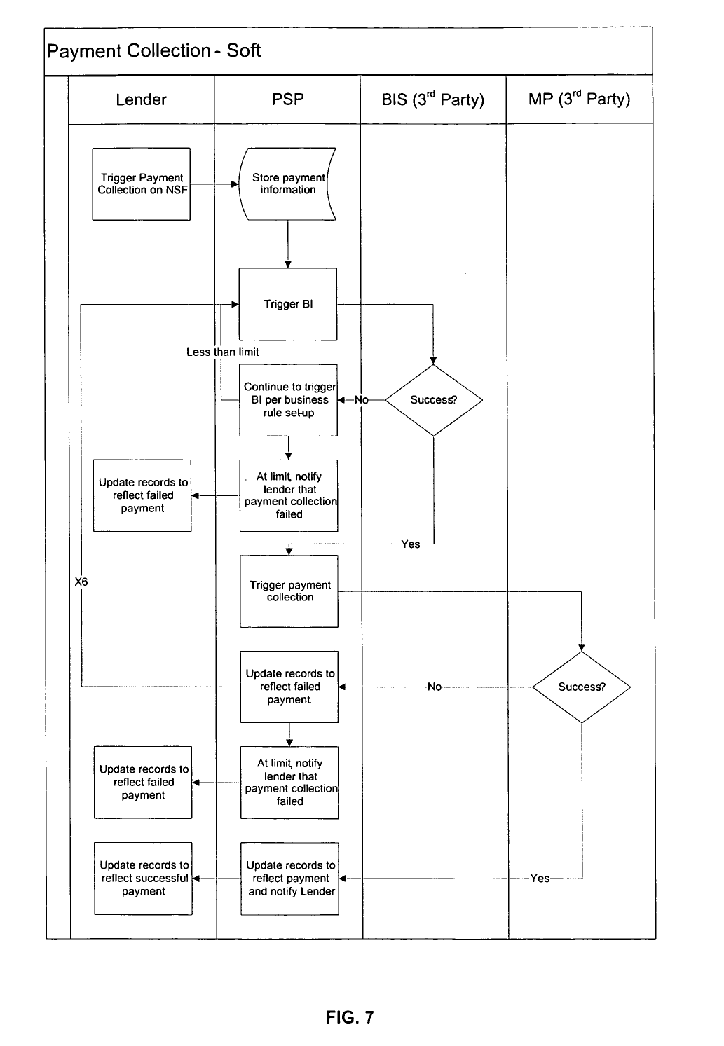

In another embodiment, a lender might sign up with a collection processor for “soft” processing. In this configuration, the lender may use the collection processor for collection of only those loans where payment or collection was unsuccessful via other methods (such as after unsuccessful use of the traditional ACH type collection process). FIG. 7 illustrates one embodiment of a payment collection process for such soft processing.

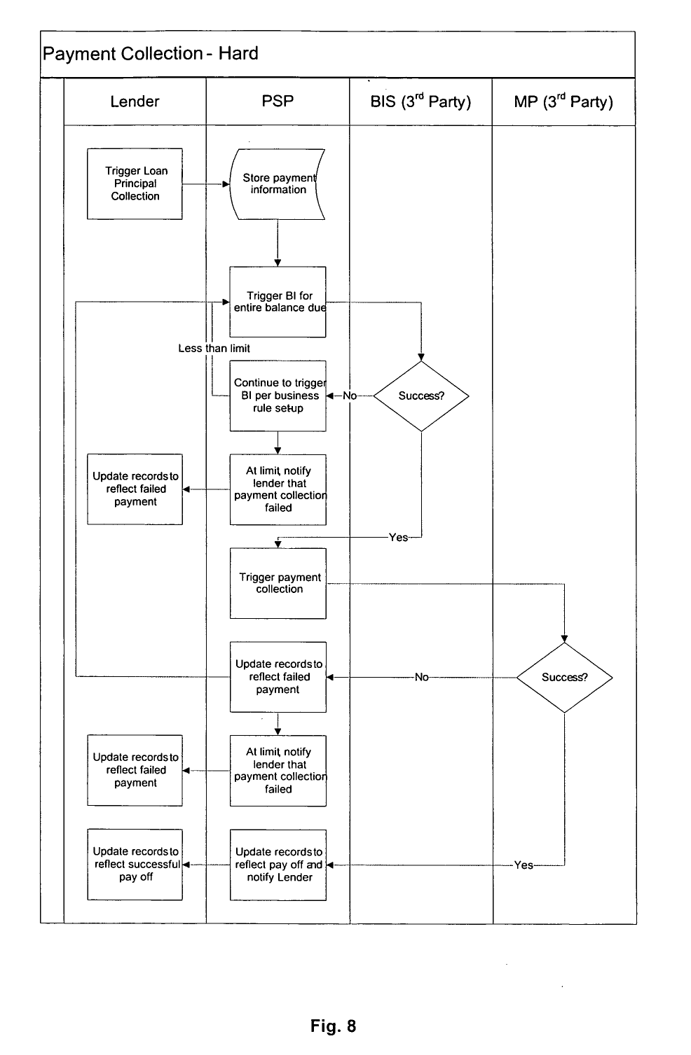

In yet another embodiment, a lender might sign up with a collection processor for “hard” processing. In this configuration, the lender may use the collection processor for collection of the remaining principal (not just an installment) of a loan. FIG. 8 illustrates one embodiment of a payment collection process for such hard processing.

Of course, the lender might elect a particular style or type of processing for each particular consumer or loan. For example, the particular type of processing may be associated with the particular loan ID. As indicated above, fees may be charged for the various processing, such as for conducting a bank card address verification, balance inquiry, collection process or the like. Such fees may vary depending upon the particular transaction type, and may include one or more third party fees (such as fees by a collection processor, a merchant processor, a bank managing clearing and/or settlement accounts or the like).

Various advantages of the invention over the prior art will now be realized.

A first advantage of the method and system is that a verification process is provided during loan application processing which increases the probability to the lender that the loan will be a good loan (i.e. that the loan will likely be repaid). In particular, during that process, the lender can verify that the consumer's information is accurate, including the consumer's bank account (consumers who do not intend to pay will often provide false information). This verification is simply and quickly performed by comparing the consumer provided address with the address with the address identified with their bank card. In addition, in one embodiment, the consumer's bank account is checked for a balance, providing some indication that the consumer will have funds to repay the loan. Again, this inquiry is quickly and simply performed by using the consumer's bank card (not their bank account) information.

A second advantage of the method and system is that during the collection or payment process, the consumer's bank account is checked for sufficient funds before the collection is attempted. This substantially improves the probability that the payment attempt will be successful, and reduces the costs associated with collection attempts.

A third advantage of the method and system is that the collection or payment process is effected as a bank card transaction, such as a bank card debit transaction against the bank account. In accordance with this type of transaction, the collection or debit of funds from the account is immediate. In particular, when the request is made, provided sufficient funds exist at that moment, the funds are immediately transferred, captured and held for settlement. This avoids the problems associated with ACH and other types of collections, wherein a collection attempt may be requested when funds are known to be available, but the collection attempt may be queued behind a number of other transactions (such as checks), such that insufficient funds exist when the transaction finally moves to the top of the queue for processing.

Yet another advantage of the system is the reduced cost to the lender in collecting funds. In accordance with the process of the invention, costly ACH transactions, insufficient funds charges and resubmission charges may be avoided. In addition, a higher success rate of collection to the lender results in higher profitability to the lender, also enabling the lender to offer better loan rates to consumers.

It will be understood that the above described arrangements of apparatus and the method there from are merely illustrative of applications of the principles of this invention and many other embodiments and modifications may be made without departing from the spirit and scope of the invention as defined in the claims.

What is claimed is:

1. A loan application and payment collection process comprising the steps of:
(a) relative to processing of a consumer's loan application:
obtaining banking verification information for a consumer relative to said loan application; and
conducting a banking verification to verify said consumer's bank account as part of an approval process of said loan application; and
(b) relative to collection of funds for a loan granted on said loan application:
obtaining information regarding a bank card associated with said consumer bank account;
scheduling a payment collection time for a particular amount of funds to be collected from said consumer bank account;
conducting a balance inquiry of said consumer bank account at said collection time;
determining if a balance of said consumer bank account exceeds said amount of funds to be collected; and
if so, collecting said amount of funds to be collected from said consumer bank account.

2. The loan application and payment collection process in accordance with claim 1 wherein said banking verification information comprises consumer address information for said consumer's bank card.

3. The loan application and payment collection process in accordance with claim 1 wherein said step of conducting said banking verification comprises conducting an address verification.

4. The loan application and payment collection process in accordance with claim 3 wherein said address verification is performed through the Address Verification System.

5. The loan application and payment collection process in accordance with claim 1 wherein said step of conducting a banking verification further comprises conducting a balance inquiry of said consumer's bank account.

6. The loan application and payment collection process in accordance with claim 1 wherein said banking verification information is provided by a consumer relative to a loan application and obtained by a collection processor from a lender.

7. The loan application and payment collection process in accordance with claim 6 wherein said banking verification information is transmitted from said lender to said collection processor in an electronic batch file.

8. The loan application and payment collection process in accordance with claim 1 wherein said information regarding a bank card comprises a bank card number.

9. The loan application and payment collection process in accordance with claim 1 wherein said step of collecting said amount of funds comprises a collection processor transmitting a request for collection to a merchant bank card processor and said merchant bank card processor using a card processing network to collect said amount of funds from said consumer bank account.

10. The loan application and payment collection process in accordance with claim 1 further comprising the step of depositing collected funds into a first bank account separate from said consumer bank account.

11. The loan application and payment collection process in accordance with claim 10 further comprising the step of deducting fees and charges from said collected funds and transferring a remaining amount of collected funds to a settlement account.

12. The loan application and payment collection process in accordance with claim 1 wherein if said balance of said consumer bank account does not exceed said amount of funds to be collected, rescheduling a payment collection time for said particular amount of funds.

13. The loan application and payment collection process in accordance with claim 1 wherein said particular amount of funds to be collected comprises an installment payment of said loan.

14. The loan application and payment collection process in accordance with claim 1 wherein said particular amount of funds to be collected comprises a principle balance of said loan.

15. A loan application and payment collection process by a collection processor comprising the steps of:
(a) relative to processing of a consumer's loan application:
obtaining banking verification information from a lender regarding a consumer's bank account; and
conducting a banking verification to verify said bank account as part of an approval process of said loan application; and
(b) relative to collection of funds for a loan granted on said loan application:
obtaining information regarding a bank card associated with said consumer bank account from said lender;
obtaining payment collection time information and amount of funds to be collected information from said lender;
scheduling said payment collection time for said particular amount of funds to be collected from said consumer bank account;
conducting a balance inquiry of said consumer bank account at said collection time;
determining if a balance of said consumer bank account exceeds said amount of funds to be collected; and
if so, transmitting a payment collection request to a bank card processor for said bank card associated with said consumer bank account for collection of said amount of funds from said consumer bank account.

16. The loan application and payment collection process in accordance with claim 15 wherein said step of conducting a banking verification comprises conducting an address verification.

17. The loan application and payment collection process in accordance with claim 16 wherein said address verification is performed through the Address Verification System.

18. The loan application and payment collection process in accordance with claim 15 wherein said step of conducting a banking verification conducting a balance inquiry of said consumer's bank account.

19. The loan application and payment collection process in accordance with claim 18 wherein said information regarding a bank card comprises a bank card number.
